(19) United States
(12) Patent Application Publication
(10) Pub. No.: US 2023/0292678 A1
(43) Pub. Date: Sep. 21, 2023

(54) UNIFORMITY OF LIGHT DISPERSION

(71) Applicant: Global Garden LLC, Torrance, CA (US)

(72) Inventor: Christopher H. Sloper, Arvada, CO (US)

(73) Assignee: Global Garden LLC, Torrance, CA (US)

(21) Appl. No.: 17/655,526

(22) Filed: Mar. 18, 2022

(51) Int. Cl. A01G 9/24; F21S 8/00; F21K 9/90

(52) U.S. Cl. CPC A01G 9/249; F21K 9/90; F21S 8/00; F21Y 2105/12

(57) ABSTRACT

A light fixture, for example a horticulture or plant growing light, that includes a plurality of light emitting elements, for example LEDs, arranged with a first portion of light emitters having a first density and a second portion having a second density, where the first density is greater than the second density, where the first portion is arranged near one or more perimeter edge of the light fixture and the second portion is arranged inward of the perimeter edge of the fixture, and where the uniformity of light dispersion from the light delivering plane of the light fixture is increased due to the first density of light emitters being greater than the second density of light emitters and due to the arrangement of the first and second portions of light emitters with respect to the light delivering plane of the fixture.

### CROSS-REFERENCE TO RELATED APPLICATIONS

None.

### FIELD

The present disclosure relates to improving light dispersion for a light or light fixture, and, more particularly, to improving the uniformity of light dispersion from a horticulture or plant grow light, especially a horticulture fixture that uses light emitting diode (LED) or other light emitting elements.

### BACKGROUND AND SUMMARY

Light fixtures designed for growing plants are commonly referred to as horticulture light fixtures, horticulture lights, plant growing light fixtures, plant growing lights, or, simply, grow lights. Such lights (or light fixtures) generally include electrical interconnections and basic circuitry for receiving electrical energy and powering or driving one or more light generating lamp(s) (or bulb(s)). A common problem exists with all grow lights, however. Existing grow lights deliver significantly more light from the center (or central portion) of the (light delivering plane of the) fixture than is delivered toward the edges or perimeter (periphery) of the (light delivering plane of the) light fixture. That is, the center has significantly more light being delivered than the edges.

What is needed are designs created to reduce the center “hot spot” and bring more light to the edges of the grow area. That is, grow lights are needed that deliver more light at the edges or toward the edges so as to a greater amount of light is delivered to the target grow area.

The problem of “hot spots” has not been adequately addressed. Many attempts have been made through hood design for HID lamps. That is, attempts have been made to design a light reflector (also sometimes referred to as a “hood”) to, for example, disperse the hot spots delivered by high intensity discharge (HID) type bulbs through creative use of reflective angles, textured or mirrored reflective materials, and/or lenses so as to reduce the hot spots or areas of higher intensity light delivered within a target grow area. The problem, however, has not been addressed in the LED market, or for light fixtures with a plurality of light emitting diodes (LEDs) or light emitters.

Using various lens and/or reflector techniques to reduce or eliminate hot spots, or improve the distribution of light delivered within a target area is inefficient due to cost disadvantages, manufacturing complexity, and other factors. Lens and/or reflector methods and structures for light fixtures that use a plurality of light emitters, such as LEDs, are ineffective at solving the problem of improving the uniformity of the light delivered by such fixtures.

To address at least some of the aforementioned and other problems, embodiments for improving the uniformity of light dispersion for a horticulture or plant grow light are provided.

According to one aspect, the uniformity of light dispersion for a horticulture or plant grow light or light fixture is improved by configuring the light fixture so as to project higher levels of light near one or more of the edges of the light fixture, so as to reduce the difference between ~ light levels projected near the one or more edges of the light fixture and light levels projected from more central areas of the light fixture.

According to another aspect, the uniformity of light dispersion is improved by developing a different matrix of LED or light emitter placement with a greater number of LEDs or light emitters at one or more edges of the fixture versus the center.

According to another aspect, a greater density of light emitters is used near the edges of the fixture so as to improve the uniformity of light dispersion from the light fixture.

According to another aspect, a density of light emitters near a perimeter edge of the fixture is greater than a density of light emitters in-board away from the perimeter edge.

According to another aspect, a plurality of light emitters is arranged, for example, on a printed circuit board, such that a density of light emitters near an outward edge is greater than a density of light emitters positioned away from the light emitters near the outward edge.

According to another aspect, a plurality of light emitters is arranged, for example, in a strip or bar (or substrate / substrate element) such that a density of light emitters near an outward end or edge is greater than a density of light emitters positioned along the strip or bar (or substrate element) opposite the outward end or edge.

According to another aspect, a plurality of light emitters is arranged, for example, in a half bar or half strip or partial strip/bar such that a density of light emitters near one end or near and outward end or edge is greater than a density of light emitters positioned along the half bar / half strip / partial strip / partial bar opposite the outward end or edge.

According to another aspect, a light fixture includes a plurality of printed circuit boards with each printed circuit board having a plurality of light emitters arranged thereon, with the light fixture configured so that a greater density of light emitters is arranged near one or more perimeter edge of the fixture so as to improve a uniformity of light dispersion of light projected from the light fixture.

According to another aspect, a light fixture includes a plurality of strips or bars with each strip or bar having a plurality of light emitters arranged thereon, with the light fixture configured so that a greater density of light emitters is arranged near one or more perimeter edge of the fixture so as to improve a uniformity of light dispersion of light projected from the light fixture.

According to another aspect, a light fixture includes a plurality of half bars / half strips / partial strips / partial bars with each half bar / half strip / partial strip / partial bar having a plurality of light emitters arranged thereon, with the light fixture configured so that a greater density of light emitters is arranged near one or more perimeter edge of the fixture so as to improve a uniformity of light dispersion of light projected from the light fixture.

According to an aspect, a uniformity of light dispersion of a light fixture is determined by measuring the light received from the light fixture at points across a target area and dividing the minimum amount measured by the average of the measurements.

According to an aspect, a uniformity of light dispersion value of a light fixture is determined by measuring the amount of light received from the light fixture at points evenly spread across a target area by measuring the photosynthetic photon flux density at each of the points across the target area, determining the minimum value of the photosynthetic photon flux density (PPFD) measurements, calculating an average photosynthetic photon flux density of the measurements, and dividing the minimum photosynthetic photon flux density value by the average photosynthetic photon flux density to obtain a uniformity of light dispersion value of the light fixture.

According to an aspect, a uniformity of light dispersion of a light fixture is improved by increasing the uniformity of light dispersion value of the light fixture, wherein the uniformity of light dispersion value of the light fixture is determined by measuring the amount of light received from the light fixture at points evenly spread across a target area by measuring the photosynthetic photon flux density at each of the points across the target area, determining the minimum value of the photosynthetic photon flux density (PPFD) measurements, calculating an average photosynthetic photon flux density of the measurements, and dividing the minimum photosynthetic photon flux density value by the average photosynthetic photon flux density to obtain a uniformity of light dispersion value of the light fixture.

According to an aspect, a uniformity of light dispersion of a light fixture is improved by increasing a uniformity of light dispersion value of the light fixture, wherein the uniformity of light dispersion value of the light fixture is determined by measuring the amount of light received from the light fixture at points evenly spread across a target area by measuring the photosynthetic photon flux density at each of the points across the target area, determining the minimum value of the photosynthetic photon flux density (PPFD) measurements, calculating an average photosynthetic photon flux density of the measurements, and dividing the minimum photosynthetic photon flux density value by the average photosynthetic photon flux density to obtain a uniformity of light dispersion value of the light fixture, by configuring the light fixture so as to project higher levels of light near one or more of the edges of the light fixture, as compared with light levels projected from more central areas of the light fixture; or by developing a different matrix of LED or light emitter placement with a greater number LEDs or light emitters at one or more edges of the fixture versus the center; or by arranging the light emitters of the light fixture so that a greater density of light emitters is used near edges of the fixture to improve the uniformity of light dispersion from the light fixture.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter and are not intended to limit the scope of the present disclosure in any way.

FIG. 1 is a perspective top view of an exemplary light fixture having a plurality of light emitters and the light fixture positioned above a target area, according to various embodiments.

FIG. 2 is a top view of a target area with exemplary measured values of photosynthetic photon flux density at various points within the target area for a prior art light fixture.

FIG. 3 is an exemplary half bar or half strip or partial strip/bar having a density of light emitters near one end or near an outward end or edge that is greater than a density of light emitters positioned along the half bar / half strip / partial strip / partial bar opposite the outward end or edge, according to various embodiments.

FIG. 4 is a plan view of a target area having a plurality of half bars / half strips / partial strips / partial bars as shown in FIG. 3, with each half bar / half strip / partial strip / partial bar positioned so that a greater density of light emitters is arranged near one or more perimeter edge of the fixture, according to various embodiments.

FIG. 5 is a top view of the target area of FIG. 4 with exemplary measured values of photosynthetic photon flux density at various points within the target area for a light fixture comprising the arrangement of light emitters in FIG. 4, according to embodiments.

FIG. 6 is a top view of the target area of FIG. 4 with exemplary measured values of photosynthetic photon flux density at the same points within the target area as in FIG. 5 for the light fixture of FIG. 4 with power to the light fixture decreased for comparison to the photosynthetic photon flux density measurements in FIG. 2, according to embodiments.

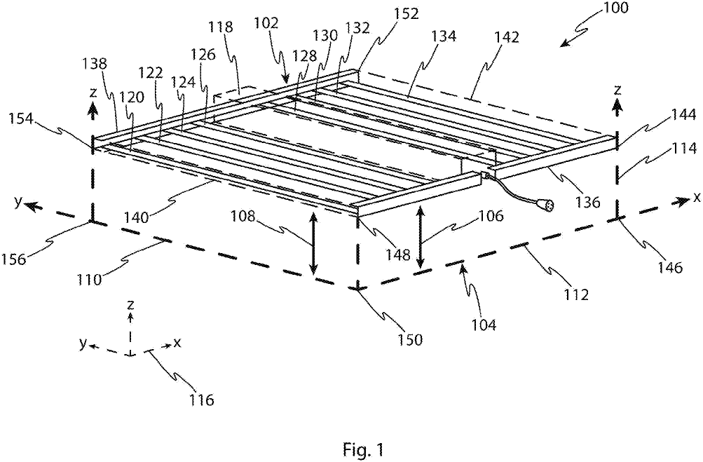

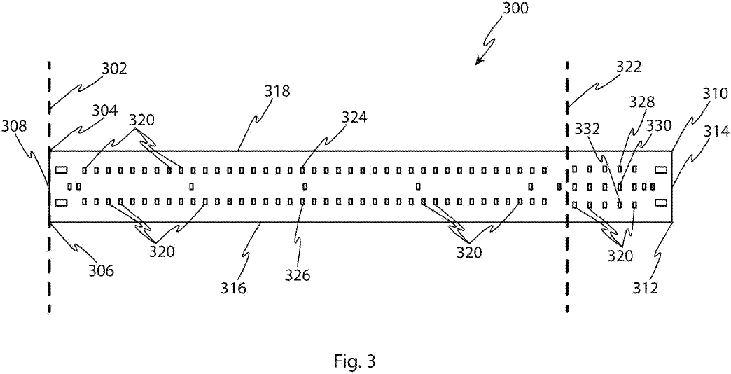

Similar reference numerals may have been used in different figures to denote similar components. FIG. 3 is shown approximately to scale. FIGS. 1, 3-6 are shown with components in proportional size with one another, according to some embodiments.

### DETAILED DESCRIPTION

It is to be understood that the disclosure may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

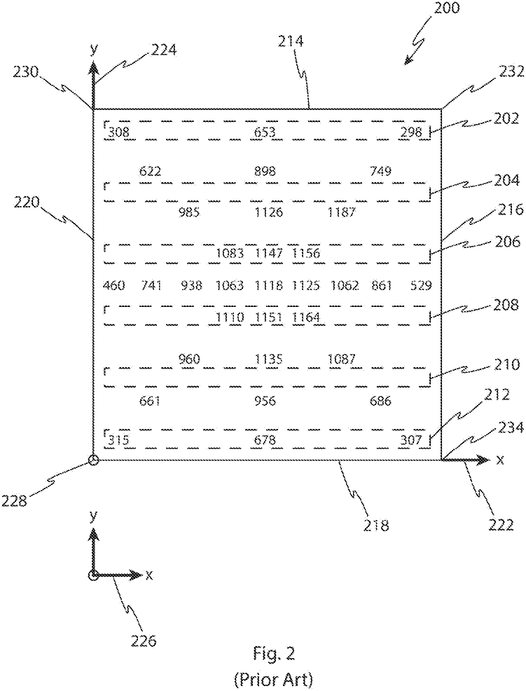

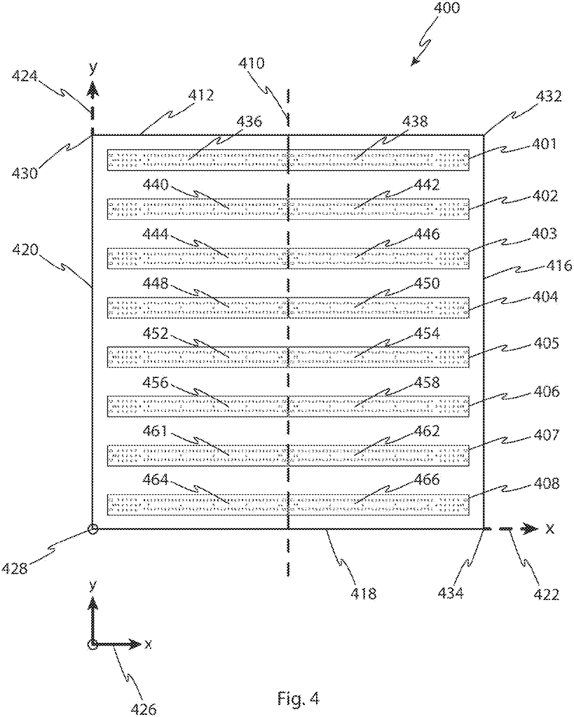

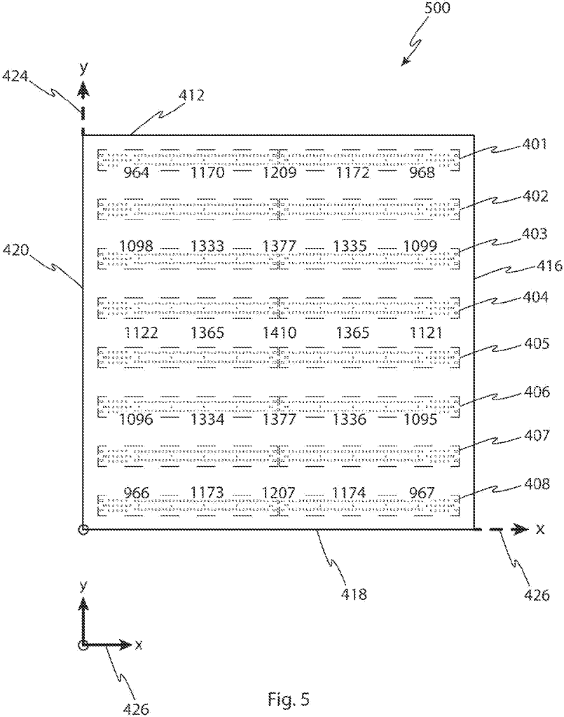

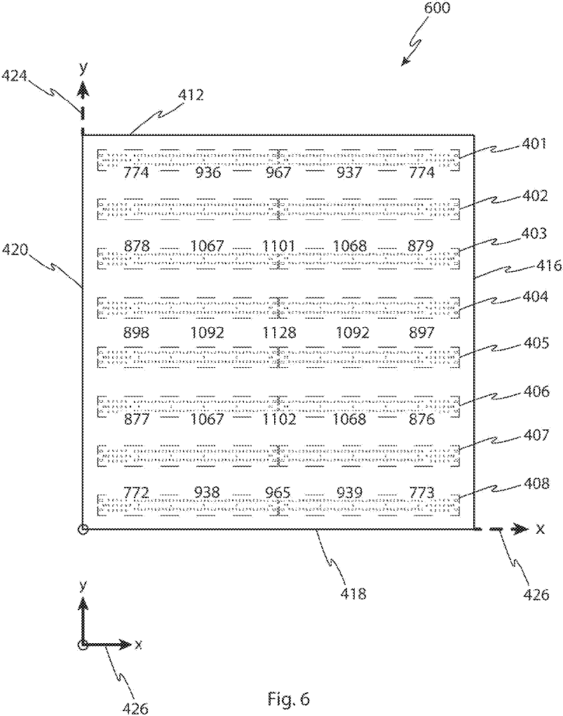

The following description relates to improving light dispersion for a light or light fixture. As an overview, FIG. 1 illustrates an exemplary light fixture 102 that incorporates a plurality of light emitters configured to deliver light onto a target area 104. FIG. 2 is a top view 200 of a target area with measured values of photosynthetic photon flux density (PPFD) at various points within the target area, as published for an existing light fixture, where the PPFD measurements show significantly higher PPFD values in the center of the target area than near the corners and edges of the target area, as is characteristic of existing LED grow lights. FIG. 3 depicts an exemplary half bar or half strip or partial strip/bar light fixture component (or strip element or substrate element) 300 having a greater density of light emitters near one end. FIG. 4 illustrates an arrangement 400 of the strip elements in FIG. 3 with respect to a target area, such as the target area 104 in FIG. 1. And FIGS. 5 and 6 show measured PPFD values across the target area for the fixture arrangement of FIG. 4, at two different power settings - a normal power setting (FIG. 5) and a reduced power setting (FIG. 6) for comparison to the PPFD measurements shown in FIG. 2.

Although the embodiments may be described in detail in the context of improving the uniformity of light dispersion from a horticulture or plant grow light, especially a horticulture fixture that uses light emitting diode (LED) or other light emitting elements, various embodiments and/or various aspects of the embodiments described may be separable and may be applied in light fixtures (or components therefor) not specifically designed for or intended for use as horticulture or grow lights.

As used herein, photosynthetic photon flux density (or PPFD) is the amount of light within the photosynthetically active radiation (PAR) range that reaches a target area or the number of photosynthetically active photons that reaches a given surface (i.e., the target area) each second. PAR is generally light emission within the photosynthetic range of wavelengths from 400 to 700 nm. PPFD measurements (or PPFD measurement values or PPFD values) are expressed in micromoles per square meter per second (i.e., µmol/m²/s or µmol m⁻² s⁻¹ or µmol/m2/s). One micromole (µmol) equals 62 quadrillion photons. The use herein of values expressed with the units µmol/m²/s or µmol m⁻² s⁻¹ or µmol/m²/s refer to PPFD measurements.

The present inventor discovered that available/existing LED grow lights have the same design flaw. The LED emitters (or individual light emitter elements) are evenly spaced across the printed circuit boards (PCBs) on which they are attached. The printed circuit boards, with the LED emitters attached thereto, are typically positioned in bars that extend from one edge of the light delivering plane of the light fixture to the other, in one dimension of the light delivering plane, and the bars are typically spaced apart from one another in the other (perpendicular) dimension of the light delivering plane. The present inventor discovered that the amount of light delivered by fixtures that use arrangements of light emitters that comprise an even spacing of the light emitters on the printed circuit boards, or that use arrangements of light emitters that comprise an even spacing (or constant or uniform density of light emitters) across the light delivering plane of the fixture, exhibit the problem of delivering significantly more light from the center of the light fixture than from the edges and outer corners of the light delivering plane. The present inventor discovered that by rearranging the positioning of the individual LEDs (or light emitters or light emitter elements), greater uniformity may be achieved. In this way, the typical hotspot(s) found in other available/existing grow lights is reduced.

Why does uniformity for flowering matter? The present inventor determined that there are at least two reasons. First, plant nutrition, the present inventor determined, drives a need for high uniformity. For example, if the center of the flowering room/tent is receiving 1200 µmol m-² s-¹ and the edges are getting less than 500 µmol m⁻² s⁻¹ of light, how are the plants fed? More light equals more nutritional demands. If the plants are fed based on the edge light level, the plants in the center will be starved; and if the plants are fed based on the center light level, the plants on the edges will be overfed.

A second reason, the present inventor determined, is greater flower size uniformity. Flower size is related to the light levels the plant receives. Keeping the light levels consistent from center to edge, the present inventor determined, improves flower size uniformity. Further, the present inventor determined that larger flowers typically have a greater calyx-to-leaf ratio which makes them easier to trim, thus saving time in harvesting the flowers. Harvesting “popcorn” sized flowers is more challenging/difficult and time-consuming, the present inventor determined than for large colas.

Why does uniformity for vegetative growth matter? The present inventor determined that, like in flowering, plant nutrition also drives a need for high uniformity in the veg state of the pant. The present inventor determined it is challenging/difficult to properly feed plants in the center of a target grow area that are receiving light at, for example, 500 µmol m⁻² s⁻¹ while closer to the edges the plants are receiving 200 µmol m⁻² s⁻¹ of light.

The present inventor determined that a second reason for maintaining high uniformity in veg is stress reduction in the early flowering phase. In most (if not all) commercial grow facilities, the present inventor determined, little consideration is given to the location of the plants in the veg room. When plants are moved into the flower room(s) they are generally loaded onto a cart and positioned where there is space in the flower room.

The presented inventor determined that if a plant that was veg’ed under 250 µmol m⁻ ² s⁻¹ is placed at the center of the flowering room (typically where the light is most intense) it will receive almost double the amount of light than it received in veg. This, the present inventor determined, causes excess stress on the plant, if not killing the plant altogether. Conversely, the present inventor further determined, if a plant that was receiving 500 µmol m⁻² s⁻¹ in veg is placed at the edge of the flowering room (typically where the light is less intense) it will have a considerable drop in the light it receives. This, the present inventor determined, will typically cause the plant to stretch and seek more light. Additionally, this can cause many hormonal responses with unknown consequences.

Why does uniformity for cloning matter? The present inventor determined that some of the worst/least healthy clones observed in a grow facility are due to poorly designed, improper, or inefficient lighting. In one facility, the present inventor determined the cause to be a serious lack of uniformity. Directly under the light source, the cuttings were receiving ∼300 µmol m⁻² s⁻¹ (PPFD). Near the edges of the growing area, the cuttings were receiving less than ∼75 µmol m⁻² s⁻ ¹ (PPFD). Clones generally have no way to feed themselves and need to rely on their stored energy until they can produce roots. The present inventor determined that the cuttings under the more intense light were burning up their energy before producing lush, healthy roots. Many of the cuttings under the more intense light were observed to have hardened, purple-colored stems that the present inventor determined to be unlikely to develop adequately or produce the desired harvest weight.

Turning now to FIG. 1, an exploded perspective view 100 of an exemplary light fixture (or grow light) 102 is shown positioned over a target area 104. The light fixture 102, as shown, includes a power plug and cord for receiving electrical power. Basic electrical interconnections and circuitry may be provided within a housing 118, which may further include circuitry for energizing or driving (or controllably energizing or driving) a plurality of light emitters or light emitting elements or LEDs arranged and positioned so as to disperse light onto the target area 104. Light fixture end members 136 and 138 may be structurally affixed with respect to the housing 118, and the end members 136, 138 may structurally support and interconnect one or more bars or strips, such as the bars 120, 122, 124, 126, 128, 130, 132, and 134. In the exemplary fixture 102, as shown, four strips or bars (or end connecting members), such as bars 120, 122, 124, and 126 are positioned on one side of the housing 118, and four strips or bars (or end connecting members), such as bars 128, 130, 132, and 134 are positioned on the other side of the housing 118. The bars, as shown in FIG. 1, are each parallel to one another and are arranged between fixture end members 136 and 138 in one direction (such as the y-axis direction indicated in x-y-z coordinate reference 116) and between fixture sides 140 and 142 in the other direction (such as the x-axis direction indicated in the coordinate reference 116). The exemplary fixture 102, as shown, includes corners 144, 152, 154, and 148, which comprise the intersection of end member 136 and side 142, side 142 and end member 138, end member 138 and side 140, and side 140 and end member 136, respectively.

It is to be understood that fixture 102, as shown and described herein, is exemplary and may have a different shape than the rectangular shape shown. The fixture 102 may, for example, have more or less than four sides, may be square or rectangular or polygonal (having many sides) or rounded on one or more side(s) (with respect to the x-y plane); or the fixture 102 may, for example, not be substantially planar (as shown in FIG. 1) but may instead have greater contours and shapes extending into the z-axis direction (more than do the structures shown for the exemplary fixture 102). That is, the fixture 102 is not limited to the substantially rectangular and planar shape as shown in FIG. 1. Further, the fixture may comprise more or less bars or strips (such as bars 120, 122, 124, 126, 128, 132, and 134) and/or more or less structural members (such as end members 136 and 138) and/or more or less side (such as sides 140 and 142). For example, the fixture 102 may comprise the eight bars shown arranged in parallel with just a single perpendicular connecting member, for example, structurally interconnecting the bars and housing 118. The fixture 102, need not include the housing 118 as shown. The bars (such as bars 120, 122, 124, 126, 128, 132, and 134) may not be arranged parallel to one another as shown in FIG. 1 or spaced apart from one another as shown in FIG. 1. Further still, the fixture 102 need not comprise any bars or strips per se, and instead utilize some other structural member such as one or more sheet(s) of material (upon which a plurality of light emitters or light emitting elements or LEDs are disposed so as to disperse light on a target area).

Similarly, the target area 104 may comprise a different shape than as shown in FIG. 1, with the different shape coinciding with a perimeter shape or the periphery of a differently shaped fixture than the rectangular shaped fixture 102 shown in FIG. 1.

As shown in FIG. 1, the target area 104 comprises a surface area (i.e., a target grow area) defined by the product of the x-axis dimension 112 between the point 150 on the x-axis below (in a z-axis direction) the corner 148 of the fixture 102 and the point 146 on the x-axis that is below (in the z-axis direction) the corner 144 of the fixture, and the y-axis dimension 110 between the point 150 on the y-axis that is below (in the z-axis direction) the corner 148 of the fixture 102 and the point 156 on the y-axis that is below (in the z-axis direction) the corner 154 of the fixture 102. The product of the dimensions 110 and 112 (that is, the length 110 times the width 112) is the surface area of the target grow area.

Also as shown in FIG. 1, the target area 104 (comprising an x-y plane defined by x-axis (width) dimension 112 and y-axis (length dimension 110)) is a z-axis (height) distance 114 away from the light delivering plane of the fixture, where the light delivering plane of the fixture is defined by the (intersecting) straight sides 136 and 140. As shown, the target area 104 is a distance 114 from the light delivering plane of the fixture 102. The distance 114 is the z-axis distance between the point 146 on the z-axis (as shown intersecting the x-axis) and the corner 144 of the fixture 102. The target area 104 is shown parallel with the light delivering plane of the fixture 102, whereby the separation between the target area 104 and the light delivering plane of the fixture 102 is the same, such as distance 106, distance 108, and z-axis distance 114 (at fixture corner 114).

Although different dimensions for the fixture 102 may be used, for purposes of the PPFD measurements described and illustrated herein, the fixture 102 comprises a four-foot by four-foot square-shaped fixture that is positioned twelve inches (or one foot) away from the target area. That is, for the PPFD measurements described herein, the light delivering plane of the light fixture in question is separated from (away from) the target area by one foot, the fixtures measure four feet by four feet (or sixteen square feet in area), and the target area, corresponding to the dimensions of the fixture in question, four feet by four feet (or sixteen square feet in surface area). As shown in FIG. 1, the dimensions 112, 136, 110, and 140 are each four feet, and the distances 114, 106, and 108 (i.e., the distance between the target area and the light delivering plane of the fixture) is one foot (or twelve inches).

Next, FIG. 2 is a top view 200 of a target area with exemplary measured values of photosynthetic photon flux density (PPFD) at various points within the target area for a prior art light fixture. The light fixture is a model Luxx 645 Watt LED Pro light fixture from Luxx Lighting Co., and the PPFD values shown in FIG. 2 (i.e., the numbers shown in a star pattern, namely 308, 653, 298, 622, 898, 749, 985, 1126, 1187, 1083, 1147, 1156, 460, 741, 938, 1068, 1118, 1125, 1062, 861, 529, 1110, 1151, 1164, 960, 1135, 1087, 661, 956, 686, 315, 678, and 307) are PPFD measurements (with the arrangement of PPFD measurements as shown in FIG. 2) published by Luxx Lighting Co. in advertising materials for the model Luxx 645 Watt LED Pro light fixture. The PPFD measurements shown in FIG. 2 are measured on a target area (on the x-y plane defined by x-axis 222 and y-axis 224) at a distance of one foot between the light delivering plane of the fixture and the target area. The Luxx 645 Watt LED Pro light fixture is a four foot by for foot light fixture with six bars, such as bars 202, 204, 206, 208, 210, and 212, understood to be arranged within four foot by four-foot perimeter sides of the fixture so as to be positioned over a four foot by four-foot target area substantially as shown in FIG. 2. Each of the bars 202, 204, 206, 208, 210, and 212 have a substantially planar surface to which LEDs are attached with an even / constant density across the surface area of the bar. That is, each of the bars (which may comprise printed circuit board (PCBs) or be referred to as PCBs) 202, 204, 206, 208, 210, and 212 include LEDs affixed to the light projecting (i.e., target area facing) surface of the bar such that the density of LEDs (or spacing between LEDs) is constant (or even or uniform) across the target area facing surface of the bar (or PCB) from one end of the bar to the other; and the bars 202, 204, 206, 208, 210, and 212 do not include any difference in the density of LEDs (or spacing between LEDs) whereby the density of LEDs is not any different (e.g., greater) closer to one (x-axis) end of the bar (or PCB) and/or the other/opposite (x-axis) end of the bar (or PCB).

As shown in FIG. 2, the target area extends from a point 228 to a point 234 along the x-axis 222, and from a point 228 to a point 230 along the y-axis 224, with the x-axis 222 and y-axis 224 oriented as indicated by the x-y-z coordinate system 226. The target area is bounded by sides 218, 216, 214, and 220. Side 218 has an x-axis dimension extending from point 228 to point 234. Side 216 has a y-axis dimension extending from point 234 on the x-axis to point 232 in the y-axis direction. Side 214 has an x-axis dimension extending from point 230 to point 232 in the x-axis direction. And side 220 has a y-axis dimension extending from point 228 to point 230 in the y-axis direction. The target area, as shown is rectangular (or, more accurately square) shaped, with each side 214, 216, 218, 220 having a dimension of four feet. The target area in the top view 200 is, therefore, as described herein, four by four feet, or sixteen square feet in surface area (across the x-y plane of the target area).

The PPFD measurement values shown in FIG. 2 are, as described above, published by Luxx Lighting Co. in an advertisement illustrating the target area and PPFD values as arranged and positioned in FIG. 2, and further include a published average PPFD value of 853 (i.e., average PPFD = 853 µmol m⁻² s⁻¹). Each of the PPFD measurement values shown in FIG. 2, namely the PPFD values 308, 653, 298, 622, 898, 749, 985, 1126, 1187, 1083, 1147, 1156, 460, 741, 938, 1068, 1118, 1125, 1062, 861, 529, 1110, 1151, 1164, 960, 1135, 1087, 661, 956, 686, 315, 678, and 307 are measured in the units µmol m⁻² s⁻¹. The arrangement of the PPFD measurement values in FIG. 2 is understood to be representative of the intensity of light dispersion from the (Luxx 645 Watt LED Pro) light fixture at various points in the target area, and such arrangement of the values in FIG. 2 is not representative of any arrangement or pattern of LED placement (i.e., on bars/PCBs 202, 204, 206, 208, 210, and 212) and, further, is not representative of a series of PPFD values that would be used in a calculation of an average PPFD delivered by the fixture onto the target area. The reason the PPFD values illustrated in FIG. 2 is not representative of a series of PPFD values that would be used in a calculation to obtain an average PPFD value is that, in order to calculate an average PPFD value, the PPDF measurements (i.e., summed up and divided by the number of measurements) should be evenly spaced apart throughout the target area, such as the PPFD measurement values illustrated in FIGS. 5 and 6, as discussed below.

As apparent from the PPFD measurement values illustrated in FIG. 2 for the Luxx 645 Watt LED Pro light fixture, PPFD values near the edges 220 and 216 are substantially lower than away from such edges and closer to the middle of the target area. For example, PPFD values of 308, 460, and 315 (µmol m⁻² s⁻¹) near edge 220 and PPFD values of 298, 529, and 307 (µmol m⁻ ² s⁻¹) near edge 216 are significantly lower than the measured PPFD values of between 1063 and 1164 (µmol m⁻² s⁻¹) in the middle area of the target area. The present inventor determined a similar drop-off of measured PPFD near the edges, and especially near the outward corners of the target area, is typical for existing LED grow lights.

The present inventor determined that a value for the uniformity of light dispersion for a fixture may be determined/calculated by dividing the minimum measured PPFD in the target area by the average PPFD delivered onto the target area. For the PPFD measurement values illustrated in FIG. 2, and assuming that the 298 µmol m⁻² s⁻¹ PPFD measurement shown near the corner 232 in FIG. 2 is the minimum PPFD measurement for the light dispersed onto the target area in FIG. 2, the uniformity of light dispersion value for the light fixture (i.e., the model Luxx 645 Watt LED Pro light fixture) is calculated as 298 µmol m⁻² s⁻¹ divided by 853 µmol m⁻² s⁻¹ which equals approximately 0.35.

The present inventor determined that calculation of a uniformity of light dispersion value for different light fixtures (and/or different light fixture conditions and/or configurations) provide a useful way to compare the uniformity of light dispersion for different fixtures (and/or different conditions and/or configurations). For example, as further discussed below with respect to FIGS. 5 and 6, the uniformity of light dispersion value for the PPFD measurements in FIG. 5 is calculated to be 964 µmol m⁻² s⁻¹ divided by (the sum of 964, 1170, 1209, 1172, 968, 1098, 1333, 1377, 1335, 1099, 1122, 1365, 1410, 1365, 1121, 1096, 1334, 1377, 1336, 1095, 966, 1173, 1207, 1174, and 967 divided by the number of PPFD measurements (i.e., 25)) µmol m⁻² s⁻¹ which equals approximately 0.83. And the uniformity of light dispersion value for the PPFD measurements in FIG. 6 is calculated to be 772 µmol m⁻² s⁻¹ divided by (the sum of 774, 936, 967, 937, 774, 878, 1067, 1101, 1068, 879, 898, 1092, 1128, 1092, 897, 877, 1067, 1102, 1068, 876, 772, 938, 965, 939, and 773 divided by the number of PPFD measurements (i.e., 25)) µmol m⁻² s⁻¹ which equals approximately 0.81.

Thus, the uniformity of light dispersion value for the PPFD measurements shown in FIG. 2 (i.e., 0.35) is substantially lower than (or less than half as much as) the uniformity of light dispersion value for the PPFD measurements shown in either FIG. 5 (i.e., 0.83) or FIG. 6 (i.e., 0.81). The present inventor determined, as supported by the empirical PPFD measurements of FIGS. 2, 5, and 6, that the inventive features described herein and incorporated into light fixtures yielding the PPFD measurements in FIGS. 5 and 6 (e.g., by arranging the light emitters of the light fixture so that a greater density of light emitters is used near edges of the fixture) results in substantially improved uniformity of light dispersion over existing fixture designs and fixture designs without such innovative features.

Moving to FIG. 3, an exemplary half bar or half strip or partial strip/bar 300 is illustrated having a density of light emitters (such as light emitters 320 comprising, for example, light emitters 328, 330, and 332 in, as shown, three rows of emitters) near one end or near an outward end or edge (such as outward edge 314) that is greater than a density of light emitters (such as light emitters 320 comprising, for example, light emitters 324 and 326 in, as shown, two rows of emitters) positioned along the half bar / half strip / partial strip / partial bar opposite the outward end or edge, according to various embodiments. As shown, the exemplary half bar or half strip or partial strip/bar 300 comprises a plurality of light emitters 320, each of which may comprise any of a variety of light emitting device, such as, for example, a light emitting diode (LED). For horticulture lights or plant growing light fixtures, each of the light emitters 320 may emit light at particular wavelengths within the aforementioned photosynthetically active radiation (PAR) range. In one embodiment, each of the adjacent light emitters 320 may be substantially the same type of emitter (for example, the same type of LED), with different ones of the light emitters 320 potentially emitting light with the same or different wavelengths of light from one another. For example, a majority of the light emitters 320 may comprise LEDs configured to emit light that appears white (within the PAR range), with a few light emitters positioned within the group of LEDs that are configured to emit light that appears more red (within the PAR range). Other types of light emitters may be included. Light emitters that emit wavelengths outside of the PAR range may be included.

As shown, in one embodiment, the half bar / half strip / partial strip / partial bar 300 comprises a substrate or substrate element having an outward edge 314 that extends longitudinally (such as along an x-axis) away from the edge 314 to an opposite end 308 and having sides 316 and 318 therebetween. The substrate or substrate element may comprise any shape. The substrate or substrate element may comprise a printed circuit board (PCB) with, for example as shown in FIG. 3, perimeter sides defined by the end, edge, and sides 308, 314, and 316, 318, respectively. As shown, end 308 extends between corners / points 304 and 306; outward edge 314 extends between corners / points 310 and 312; side 318 extends between corners / points 304 and 310; and side 316 extends between corners / points 306 and 312. The light emitters 320 may be interconnected on the PCB so as to be configured to disperse light from one planar side of the PCB. For example, the plane defined by end, edge, and sides 308, 314, and 316, 318, respectively, may be arranged so as to project or disperse light substantially orthogonally (or perpendicular) away from the surface facing a target area or a target grow area.

FIG. 3 illustrates, according to one embodiment, a transparent top view of a half bar / half strip / partial strip / partial bar (or substrate element) 300 in an x-y plane and having a plurality of light emitting element or light emitters 320 that are attached to the substrate element (such as a PCB) and directed into the page (i.e., in the z-axis direction) toward a target area (not shown) there below. As shown in FIG. 3, light emitting elements 320 within the portion of the substrate element 300 near the outward edge 314 of the substrate element, such as between the positions marked 322 and the outward edge 314, are arranged so as to have a greater density than for light emitting elements 320 positioned away from the outward edge portion, such as between the position marked 322 and the position marked 302 that is shown comprising the end 308 of the substrate element opposite the outward edge 314. That is, the light emitters 320 within the portion between 322 and the outward edge 314 are arranged so as to have a greater number of light emitters 320 per unit substrate area than within the portion of the substrate between 322 and 302 that extends away from the outward edge 314. In one embodiment, as shown in FIG. 3, the light emitting elements 320 near the outward edge 314 are arranged in three rows (with each row extending longitudinally between the outward edge 314 and the position marked 322). In one embodiment, as shown in FIG. 3, the light emitting elements 320 that are positioned opposite the edge portion, between the position marked 322 and extending toward the opposite end 308, are arranged in two rows. In one embodiment, the outward edge portion of the PCB or substrate (or half bar or half strip) comprises fifteen light emitters or LEDs arranged in three rows and five columns, and with the LEDs spaced apart from one another so as to define a first density of light emitters; and the portion of the substrate or PCB extending away (opposite) from the outward edge portion comprises seventy-eight light emitters or LEDs arranged in two rows and thirty-nine columns, and with the LEDs spaced apart from one another so as to define a second density of light emitters, wherein the first density of light emitters is greater than the second density of light emitters. As shown in FIG. 3, the portion of the substrate near the edge 314 is configured with a higher density of light emitters 320 so as to project higher levels of light near the edges 314, as compared with light levels projected from light emitters 320 positioned within more central areas of the substrate and from areas of the substrate extending away from the edge portion near edge 314.

FIG. 4 is a plan view of a target area 400 having a plurality of half bars / half strips / partial strips / partial bars / substrate elements as shown in FIG. 3, with each half bar / half strip / partial strip / partial bar / substrate element positioned so that a greater density of light emitters is arranged near one or more perimeter edge of the fixture, according to various embodiments. In one embodiment, the light fixture (such as light fixture 102) is oriented over a target area as described with respect to FIG. 1 and comprises sixteen of the substrate elements as shown and described with respect to FIG. 3, with each of the substrate elements 436, 438, 440, 442, 444, 446, 448, 450, 452, 454, 456, 458, 461, 462, 464, 466 comprising a substrate element as described with respect to FIG. 3 and oriented and positioned as shown in FIG. 4, so that the outward edge of each substrate element 300 having the higher density of light emitters is positioned to be near a perimeter edge of the light fixture. As shown in FIG. 4, substrate elements 438, 442, 446, 450, 454, 458, 462, and 466 each comprise a substrate element 300 with the outward edge 314 of each substrate element positioned near target area side 416 that extends from point 434 on the x-axis 422 of the target area to point 432 in the y-axis 424 direction; substrate elements 436, 440, 444, 448, 452, 456, 461, and 464 each comprise a substrate element 300 with the outward edge 314 of each substrate element positioned (flipped from the orientation shown in FIG. 3) near target area side 420 that extends from point 428 on the y-axis of the target area to point 430 on the y-axis 424.

In one embodiment, the light fixture (such as a light fixture that may be similar to fixture 102 in FIG. 1) may comprise eight bars / strips / substrate elements 401, 402, 403, 404, 405, 406, 407, and 408, each of which comprises two substrate elements 300 as described with respect to FIG. 3, and each having an (inward) end 308 at the positioned marked 302 (in FIG. 3) aligned along an x-axis mid-line (or mid-point line) 410 (as shown in FIG. 4). In one embodiment, structure supporting each of the eight full bar / full strip substrate elements 401, 402, 403, 404, 405, 406, 407, and 408 may be the same or similar to or comprise features of the light fixture 102 in FIG. 1. In one embodiment, the bars 120, 122, 124, 126, 128, 132, and 134 as described above with respect FIG. 1 may comprise the substrate elements 401, 402, 403, 404, 405, 406, 407, and 408 and may be oriented above a target area 104 as described above with respect to FIG. 1, so as to provide the PPFD measurements shown in FIGS. 5 and 6. The two substrate elements 300 that comprise each of the full bar / full strip type substrate elements shown in FIG. 4, may be interconnected with one another via one or more structural bars or strips, such as structural members comprising the bars 120, 122, 124, 126, 128, 130, 132, and 134 shown in FIG. 1.

For purposes of the PPFD measurement values shown in FIGS. 5 and 6, the light fixture comprising the substrate elements and light emitters as arranged and oriented as shown in FIG. 4, comprises, like the fixture 102 in FIG. 1, a four foot by four foot square-shaped fixture with perimeter sides of the fixture that line up (in the z-axis direction) with sides 412, 416, 418, and 420 of the target area 400 and as oriented relative to the x-y-z coordinates 426 (FIG. 4), and with a (z-axis direction) separation between the target area 400 and the light delivering plane of the light fixture being one foot, as described with respect to FIG. 1 and set out relative to the x-y-z coordinates 116 illustrated in FIG. 1. In this way, inventive features are described with respect to FIGS. 1, 3, and 4, were used by the present inventor to obtain the PPFD measurement values shown in FIGS. 5 and 6.

FIG. 5 illustrates a top view 500 of the target area of FIG. 4 with exemplary measured values of photosynthetic photon flux density (PPFD) at various points within (and evenly spaced throughout) the target area (wherein the target area is circumscribed by the sides 412, 416, 418, and 420) for a light fixture comprising the arrangement of substrate elements (and light emitters thereon) illustrated in FIG. 4, according to embodiments. As shown in FIG. 5, the PPFD measurement values (in µmol m⁻² s⁻¹) are 964, 1170, 1209, 1172, 968, 1098, 1333, 1377, 1335, 1099, 1122, 1365, 1410, 1365, 1121, 1096, 1334, 1377, 1336, 1095, 966, 1173, 1207, 1174, and 967. The average of the PPFD measurements shown in FIG. 5 is the sum of 964, 1170, 1209, 1172, 968, 1098, 1333, 1377, 1335, 1099, 1122, 1365, 1410, 1365, 1121, 1096, 1334, 1377, 1336, 1095, 966, 1173, 1207, 1174, and 967 divided by the number of measurements (i.e., 25), or 1153 in µmol m⁻² s⁻¹.

Notably, although the PPFD values near the edges of the target area are lower than for more central areas under the light fixture, the drop off in light intensity between the central areas and the outward edges for the PPFD measurements in FIG. 5 is less than the drop off in light intensity between the central areas and the outward edges for the PPFD measurements in FIG. 2. For example, the PPFD value near the edge 416 (in FIG. 5) under the substrate elements 404 and 405 is 1120 µmol m⁻² s⁻¹, the PPFD value near the edge 420 under the substrate elements 404 and 405 is 1122 µmol m⁻² s⁻¹, and the PPFD value at the center of the target area 500 is 1410 µmol m⁻² s⁻¹. The drop-off in light intensity from the center to the edges is about 289 µmol m⁻² s⁻¹ or about 20 percent. In contrast, the PPFD value near the edge 216 (in FIG. 2) under the bars 206 and 208 is 529 µmol m⁻² s⁻¹, the PPFD value near the edge 220 under the bars 206 and 208 is 460 µmol m⁻² s⁻¹, and the PPFD value at the center of the target area 200 is 1118 µmol m⁻² s⁻¹; and the drop off in light intensity from the center to the edges is about 589 to 658 µmol m⁻² s⁻¹ or about to 52 to 58 percent.

Thus, as the present inventor discovered, the arrangement of light emitters as in FIG. 4 (having a greater density of light emitters positioned near the outward edge of the light fixture) substantially increases the levels of light projected near the edges of the light fixture so as to substantially reduce the drop off in light intensity or difference between light levels projected from the central areas of the light fixture to the light levels projected from areas near the edges of the light fixture. In this way, as the present inventor discovered, so-called hot spots characteristic for existing light fixtures are reduced (and uniformity of the light delivered from the light fixture is improved).

As previously described, the present inventor determined that a value for the uniformity of light dispersion for a fixture may be determined/calculated by dividing the minimum measured PPFD in the target area by the average PPFD delivered onto the target area. The uniformity of light dispersion value for the PPFD measurements in FIG. 5 (for the light fixture having the light emitters arranged and configured as shown in FIG. 4) may be calculated to be 964 µmol m⁻² s⁻¹ (i.e., the minimum PPFD measurement value in the target area shown in FIG. 4) divided by (the average PPFD value for the target area, i.e., the sum of 964, 1170, 1209, 1172, 968, 1098, 1333, 1377, 1335, 1099, 1122, 1365, 1410, 1365, 1121, 1096, 1334, 1377, 1336, 1095, 966, 1173, 1207, 1174, and 967 divided by the number of PPFD measurements (i.e., 25)) µmol m⁻² s⁻¹ which equals approximately 0.83. In contrast, the calculated uniformity of light dispersion value, as described above, for the PPFD measurements in FIG. 2 is 0.35, or less than half the uniformity value calculated for a light fixture having an arrangement of light emitters whereby a density of light emitters near the edges of the light fixture is greater than a density of light emitters inward from the edges, as shown and described with respect to FIG. 4.

Turning to FIG. 6, a top view 600 of the target area of FIG. 4 is illustrated with exemplary measured values of photosynthetic photon flux density (PPFD) at the same points within the target area as in FIG. 5 for the same light fixture of FIG. 4, but with electrical power to the light fixture decreased (so as to equal to that of the Luxx 645 Watt LED Pro light fixture) for a more direct comparison to the photosynthetic photon flux density (PPFD) measurements depicted in FIG. 2, according to embodiments. As shown in FIG. 6, the PPFD measurement values (in µmol m⁻² s⁻¹) are 774, 936, 967, 937, 774, 878, 1067, 1101, 1068, 879, 898, 1092, 1128, 1092, 897, 877, 1067, 1102, 1068, 876, 772, 938, 965, 939, and 773. The average of the PPFD measurements shown in FIG. 6 is the sum of 774, 936, 967, 937, 774, 878, 1067, 1101, 1068, 879, 898, 1092, 1128, 1092, 897, 877, 1067, 1102, 1068, 876, 772, 938, 965, 939, and 773 divided by the number of measurements (i.e., 25), or 955 in µmol m⁻² s⁻¹.

As noted for the PPFD measurement values in FIG. 5, the PPFD values near the edges of the target area 600 (in FIG. 6) are lower than for more central areas under the light fixture; however, the drop off in light intensity between the central areas and the outward edges for the PPFD measurements in FIG. 6 is (similar to the drop off noted with respect to FIG. 5) less than the drop off in light intensity between the central areas and the outward edges for the PPFD measurements in FIG. 2. For example, the PPFD value near the edge 416 (in FIG. 6) under the substrate elements 404 and 405 is 897 µmol m⁻² s⁻¹, the PPFD value near the edge 420 under the substrate elements 404 and 405 is 898 µmol m⁻² s⁻¹, and the PPFD value at the center of the target area 600 is 1128 µmol m⁻² s⁻¹. The drop-off in light intensity from the center to the edges is about 231 µmol m⁻² s⁻¹ or about 20 percent. In contrast, as described above for the comparable portion of the target area in FIG. 2, the drop-off in light intensity from the center to the edges is about 589 to 658 µmol m⁻² s⁻¹ or about to 52 to 58 percent. Thus, for both the PPFD values in FIG. 5 and the power decreased measurements of PPFD values in FIG. 6, the arrangement of light emitters as in FIG. 4 (having a greater density of light emitters positioned near the outward edge of the light fixture) substantially increases the levels of light projected near the edges of the light fixture so as to substantially reduce the drop off in light intensity or difference between light levels projected from the central areas of the light fixture to the light levels projected from areas near the edges of the light fixture.

Further, whereas the average PPFD for FIG. 2, as described above, is published as 853 µmol m⁻² s⁻¹, the average PPFD for FIG. 6 is 955 µmol m⁻² s⁻¹, and the uniformity of light dispersion value for the PPFD measurements in FIG. 6 is calculated to be 772 µmol m⁻² s⁻¹ divided by (the sum of 774, 936, 967, 937, 774, 878, 1067, 1101, 1068, 879, 898, 1092, 1128, 1092, 897, 877, 1067, 1102, 1068, 876, 772, 938, 965, 939, and 773 divided by the number of PPFD measurements (i.e., 25)) µmol m⁻² s⁻¹ which equals approximately 0.81. In contrast, the calculated uniformity of light dispersion value, as described above, for the PPFD measurements in FIG. 2 is 0.35, or less than half the uniformity value calculated for a light fixture utilizing the same level of electrical power and having an arrangement of light emitters whereby a density of light emitters near edges of the light fixture is greater than a density of light emitters inward from such edges, as shown and described with respect to FIG. 4.

Thus, as the present inventor discovered, the arrangement of light emitters as in FIG. 4 (having a greater density of light emitters positioned near the outward edge of the light fixture) increases the levels of light projected near the edges of the light fixture so as to substantially improve the uniformity of light delivered from the light fixture. In this way, as the present inventor discovered, uniformity of the light delivered from a light fixture is improved and, further, so-called hot spots, characteristic of existing LED type light fixtures, are reduced.

FIGS. 1, 3, and 4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of the element may be referred to as a “top” of the component and a bottommost element or point of the element may be referred to as a “bottom” of the component, in at least one example. As used herein, top/bottom, upper/lower, above/below, may be relative to a vertical axis of the figures and used to describe the positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Certain adaptations and modifications of the described embodiments can be made. Therefore, the above-discussed embodiments are considered to be illustrative and not restrictive. The present disclosure is not to be limited in scope by the specific embodiments described herein. Further example embodiments may also include all of the steps, features, compositions and compounds referred to or indicated in this description, individually or collectively and any and all combinations or any two or more of the steps or features.

Throughout this document, the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more. The words “comprising” (and any form of comprising, such as “comprise’ and comprises), “having” (and any form of having, such as “have” and “has”), “including” (and any form of including, such as “include” and “includes”) or “containing” (and any form of containing, such as “contain” and “contains”), are inclusive or openended and do not exclude additional, unrecited elements or process steps.

In the present specification and in the appended claims, various terminology which is directional, geometrical and/or spatial in nature such as “longitudinal”, “horizontal”, “front”, “forward”, “backward”, “back”, “rear”, “upwardly”, “downwardly”, etc. is used. It is to be understood that such terminology is used for ease of description and in a relative sense only and is not to be taken in any way as specifying an absolute direction or orientation.

The embodiments described herein may include one or more range of values (for example, size, displacement and field strength etc.). A range of values will be understood to include all values within the range, including the values defining the range, and values adjacent to the range that lead to the same or substantially the same outcome as the values immediately adjacent to that value which defines the boundary to the range. For example, a person skilled in the field will understand that a 10% variation in upper or lower limits of a range can be totally appropriate and is encompassed by the disclosure. More particularly, the variation in upper or lower limits of a range will be 5% or as is commonly recognized in the art, whichever is greater.

Throughout this specification relative language such as the words ‘about’ and ‘approximately’ are used. This language seeks to incorporate at least 10% variability to the specified number or range. That variability maybe plus 10% or negative 10% of the particular number specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through the presentation of new claims in this or a related application. Such claims, whether broader, narrower, equal, or different in scope to the original claims, also are regarded as included within the subject matter of the present disclosure.

What is claimed is:

1. A light fixture comprising a plurality of light emitters configured so as to project higher levels of light near one or more outward edge(s) of the light fixture than areas inward of the one or more outward edge, wherein a difference between light levels projected near the one or more outward edge and light levels projected from areas inward of the one or more outward edge is reduced.

2. The light fixture of claim 1, wherein the light fixture is configured to have a greater number of light emitters near one or more outward edge(s) than for central areas of the light fixture inward of the one or more outward edge so as to increase a uniformity of light dispersion of the light fixture.

3. The light fixture of claim 1, wherein a greater density of light emitters is arranged near one or more outward edge(s) of the fixture than for areas inward of the one or more outward edge(s) so as to increase a uniformity of light dispersion from the light fixture.

4. The light fixture of claim 1, wherein a density of light emitters near a perimeter edge of the fixture is greater than a density of light emitters arranged inward away from the perimeter edge.

5. The light fixture of claim 1, wherein a portion of the plurality of light emitters is arranged on a printed circuit board such that a density of light emitters near an outward edge of the printed circuit board is greater than a density of light emitters positioned away from the light emitters near the outward edge of the printed circuit board.

6. The light fixture of claim 1, wherein a portion of the plurality of light emitters is arranged on a substrate element extending between pair of opposite outward edges of the light fixture such that a density of light emitters near one or more of the pair of outward edges is greater than a density of light emitters positioned along the substrate element away from the one or more of the pair of outward edges.

7. The light fixture of claim 1, wherein a plurality of light emitters is arranged on a substrate element extending away from an outward edge of the light fixture such that a density of light emitters near the outward edge is greater than a density of light emitters positioned along the substrate opposite the outward edge.

8. The light fixture of claim 1, further comprising a plurality of printed circuit boards with each printed circuit board having a portion of the plurality of light emitters arranged thereon, and with the light fixture configured so that a greater density of light emitters is arranged near one or more perimeter edge of the fixture so as to increase a uniformity of light dispersion of light projected from the light fixture.

9. The light fixture of claim 1, further comprising a plurality of substrate elements extending between perimeter edges of the light fixture, with each substrate element having a portion of the plurality of light emitters arranged thereon, and with the light fixture configured so that a greater density of light emitters is arranged near one or more perimeter edge of the fixture so as to increase a uniformity of light dispersion of light projected from the light fixture.

10. The light fixture of claim 1, further comprising a plurality of substrate elements extending away from a perimeter edge of the light fixture, with each substrate element having a portion of the plurality of light emitters arranged thereon, and with the light fixture configured so that a greater density of light emitters is arranged near one or more perimeter edge of the fixture so as to increase a uniformity of light dispersion of light projected from the light fixture.

11. The light fixture of claim 3, wherein the uniformity of light dispersion of the light fixture is determined by measuring light received from the light fixture at points across a target area and dividing the minimum amount measured by the average of the measurements.

12. The light fixture of claim 3, wherein the uniformity of light dispersion of the light fixture comprises a uniformity of light dispersion value of the light fixture determined by measuring an amount of light received from the light fixture at points evenly spread across a target area to obtain a measured photosynthetic photon flux density (PPFD) at each of the points across the target area, determining a minimum value of the photosynthetic photon flux density (PPFD) measurements, calculating an average photosynthetic photon flux density of the measurements, and dividing the minimum photosynthetic photon flux density value by the average photosynthetic photon flux density to obtain the uniformity of light dispersion value of the light fixture.

13. The light fixture of claim 1, wherein the plurality of light emitters comprises a plurality of light emitting diodes (LEDs).

14. The light fixture of claim 1, wherein the light fixture comprises a horticulture light fixture or a plant growing light fixture.

15. A light fixture having a plurality of light emitters arranged with a first portion of the plurality of light emitters having a first density with respect to a light delivering plane of the fixture and a second portion of the plurality of light emitters having a second density with respect to the light delivering plane of the fixture, wherein the first density is greater than the second density, wherein the first portion of the plurality of light emitters is arranged near one or more perimeter outward edge of the light fixture and the light delivering plane, wherein the second portion of the plurality of the light emitters is arranged inward from the one or more perimeter outward edge and encompassing a central area of the light fixture and the light delivering plane, and wherein a uniformity of light dispersion from the light delivering plane of the light fixture is increased due to the first density of light emitters being greater than the second density of light emitters and the arrangement of the first and second portions of the plurality of light emitters with respect to the light delivering plane of the fixture.

16. The light fixture of claim 15, wherein the plurality of light emitters comprises a plurality of light emitting diodes (LEDs).

17. The light fixture of claim 15, wherein the light fixture comprises a horticulture light fixture or a plant growing light fixture.

18. The light fixture of claim 15, wherein the uniformity of light dispersion from the light delivering plane of the light fixture comprises a uniformity of light dispersion value of the light fixture that is determined by measuring an amount of light received from the light fixture light delivering plane at points evenly spread across a target area to obtain a measured photosynthetic photon flux density (PPFD) at each of the points across the target area, determining a minimum value of the photosynthetic photon flux density (PPFD) measurements, calculating an average photosynthetic photon flux density of the measurements, and dividing the minimum photosynthetic photon flux density value by the average photosynthetic photon flux density to obtain the uniformity of light dispersion value of the light fixture.

19. A method of increasing a uniformity of light dispersion of a light fixture, the method comprising:
providing the light fixture having a plurality of light emitters arranged to project light from a light delivering plane of the fixture onto a target area therebelow, wherein the uniformity of light dispersion of the light fixture comprises a uniformity of light dispersion value of the light fixture that is determined by measuring an amount of light received from the light delivering plane at points evenly spread across the target area to obtain a measured photosynthetic photon flux density (PPFD) at each of the points across the target area, determining a minimum value of the photosynthetic photon flux density (PPFD) measurements, calculating an average photosynthetic photon flux density of the measurements, and dividing the minimum photosynthetic photon flux density value by the average photosynthetic photon flux density to obtain the uniformity of light dispersion value of the light fixture; and
configuring the light emitters of the light fixture so as to project higher levels of light near one or more perimeter edge(s) of the light fixture, as compared with light levels projected from central areas of the light fixture positioned inward and away from the one or more perimeter edge, and thereby increase the uniformity of light dispersion value of the light fixture; or
configuring the light fixture to have a greater number of light emitters near one or more perimeter edge(s) of the light fixture than for central areas of the light fixture that are inward from the one or more perimeter edge, and thereby increase the uniformity of light dispersion value of the light fixture; or
arranging the plurality of light emitters of the light fixture so that a first portion of the plurality of light emitters near one or more perimeter edge(s) of the light fixture has a greater density of light emitters than a second portion of the plurality of light emitters positioned inward of the one or more perimeter edge, and thereby increase the uniformity of light dispersion value of the light fixture.

20. The method of claim 19, wherein the plurality of light emitters comprises a plurality of light emitting diodes (LEDs).
